(19) United States
(12) Patent Application Publication
(10) Pub. No.: US 2018/0121883 A1
(43) Pub. Date: May 3, 2018

(54) APPARATUS AND METHOD FOR RECOMMENDING MEETING PLACE

(71) Applicant: WE MEET, INC., Ansan-si (KR)

(72) Inventor: Gwisun KANG, Gimpo-si (KR)

(73) Assignee: WE MEET, INC., Ansan-si (KR)

(21) Appl. No.: 15/800,046

(22) Filed: Oct. 31, 2017

(30) Foreign Application Priority Data
Oct. 31, 2016 (KR) 10-2016-0142967

(51) Int. Cl. G06Q 10/10; G01C 21/34; G01C 21/36

(52) U.S. Cl. CPC G06Q 10/1095; G01C 21/3438; G01C 21/3679; G01C 21/3415; G01C 21/3676; G01C 21/343

(57) ABSTRACT

Disclosed is method and apparatus for recommending a meeting place, the apparatus including an interface configured to receive a place option and locations of a plurality of user terminals and a processor configured to determine a point to which a distance from each of the plurality of user terminals is within a preset range based on the locations of the plurality of user terminals and recommend a meeting place based on the determined point and the place option.

### CROSS-REFERENCE TO RELATED APPLICATIONS

This application claims the benefit of Korean Patent Application No. 10-2016-0142967, filed on Oct. 31, 2016, the contents of which are incorporated herein by reference.

### FIELD OF THE INVENTION

One or more example embodiments relate to a method and apparatus for recommending a meeting place based on locations of a plurality of user terminals.

### BACKGROUND OF THE INVENTION

In modern society, various meetings are held for the purpose of work or leisure.

However, because locations, for example, starting locations of people attending a meeting are different, it is not easy to select a meeting place at a preferred location for all of the people.

Also, even if the meeting place is located at a point to which distances from the people are similar, the meeting place may not be suitable for a purpose of meeting.

Accordingly, there is a desire for technology for recommending an optimal meeting place based on a purpose of meeting and locations of people attending to the meeting.

### SUMMARY OF THE INVENTION

An aspect is to determine a point to which a distance from each of a plurality of user terminals is within a preset range based on locations of the plurality of user terminals and recommend a meeting place based on the determined point and a place option reflecting a meeting purpose, thereby recommending an optimal meeting place that is located in the middle relative to the locations of the plurality of user terminals and suitable for the meeting purpose.

Another aspect is to verify an amount of time for moving from a location of each of a plurality of user terminals to a recommended meeting place based on real-time traffic information before a time set based on a meeting time at the meeting place and change the meeting place based on a location of a user terminal corresponding to a largest amount of time for moving to the meeting place, and recommend a meeting place again based on a real-time traffic situation such that the meeting starts quickly.

According to an aspect, there is provided a meeting place recommending apparatus including an interface configured to receive a place option and locations of a plurality of user terminals and a processor configured to determine a point to which a distance from each of the plurality of user terminals is within a preset range based on the locations of the plurality of user terminals and recommend a meeting place based on the determined point and the place option.

According to another aspect, there is also provided a meeting place recommending method including receiving a place option and locations of a plurality of user terminals, determining a point to which a distance from each of the plurality of user terminals is within a preset range based on the locations of the plurality of user terminals, and recommending a meeting place based on the determined point and the place option.

According to an aspect, it is possible to determine a point to which a distance from each of a plurality of user terminals is within a preset range based on locations of the plurality of user terminals and recommend a meeting place based on the determined point and a place option reflecting a meeting purpose, thereby recommending an optimal meeting place that is located in the middle relative to the locations of the plurality of user terminals and suitable for the meeting purpose.

According to another aspect, it is possible to verify an amount of time for moving from a location of each of a plurality of user terminals to a recommended meeting place based on real-time traffic information before a time set based on a meeting time at the meeting place and change the meeting place based on a location of a user terminal corresponding to a largest amount of time for moving to the meeting place, and recommend a meeting place again based on a real-time traffic situation such that the meeting starts quickly.

### BRIEF DESCRIPTION OF THE DRAWINGS

FIG. 1 is a diagram illustrating a network including a meeting place recommending apparatus according to an example embodiment.

FIG. 2 is a diagram illustrating a meeting place recommending apparatus according to an example embodiment.

FIG. 3 is a diagram illustrating an example of a meeting place recommending apparatus receiving a location of a user terminal according to an example embodiment.

FIG. 4 is a diagram illustrating an example of a meeting place recommending apparatus receiving a place option according to an example embodiment.

FIG. 5 is a diagram illustrating an example of a meeting place recommending apparatus recommending a meeting place according to an example embodiment.

FIG. 6 is a diagram illustrating an example of a meeting place recommending apparatus providing meeting schedule information according to an example embodiment.

FIG. 7 is a flowchart illustrating a meeting place recommending method according to an example embodiment.

### DETAILED DESCRIPTION OF THE INVENTION

Hereinafter, some example embodiments will be described in detail with reference to the accompanying drawings.

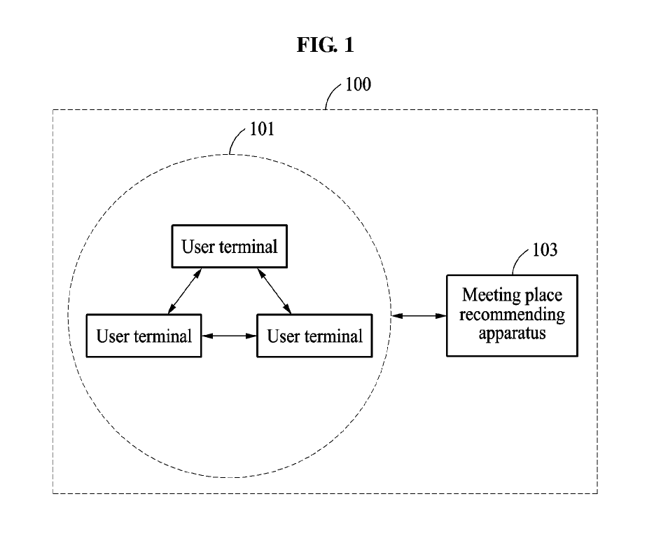

FIG. 1 is a diagram illustrating a network including a meeting place recommending apparatus according to an example embodiment.

Referring to FIG. 1, a network 100 may include a plurality of user terminals 101 and a meeting place recommending apparatus 103.

The plurality of user terminals 101 may be, for example, smartphones and tablet PCs. The plurality of user terminals 101 may communicate with one another. The plurality of user terminals 101 may communicate, for example, in a group chat room of a social network service (SNS) with one another.

Also, each user terminal may communicate with the meeting place recommending apparatus 103. For example, a user terminal may generate a meeting place recommendation request and transmit the meeting place recommendation request to the meeting place recommending apparatus 103. Also, the user terminal may receive a meeting place from the meeting place recommending apparatus 103 as a response to the meeting place recommendation request.

In this example, the user terminal may receive a location, for example, a current location and a starting location, of each user terminal associated with a meeting and a place option reflecting a purpose of the meeting. Also, the user terminal may transmit the meeting place recommendation request including the received location of each user terminal and the place option to the meeting place recommending apparatus 103.

When a meeting place recommendation request is received from a user terminal among the plurality of user terminals 101, the meeting place recommending apparatus 103 may extract a place option and a location of each user terminal associated with a meeting from the meeting place recommendation request, determine a meeting place based on the place option and the location of each user terminal, and provide the meeting place to the user terminal having generated the meeting place recommendation request. When the meeting place recommendation request is generated by the user terminal in interconnection with a group chat room on an SNS, the location of each user terminal associated with the meeting may be replaced by a location of each user terminal of the group chat room.

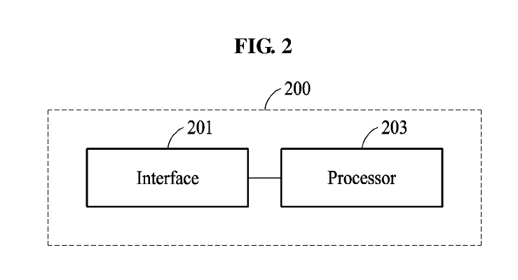

FIG. 2 is a diagram illustrating a meeting place recommending apparatus according to an example embodiment.

Referring to FIG. 2, a meeting place recommending apparatus 200 may include an interface 201 and a processor 203.

The interface 201 may receive locations, for example, current locations of a plurality of user terminals and a place option. The interface 201 may receive the locations of the plurality of user terminals associated with a meeting from a first user terminal in which a meeting place recommendation request occurs among the plurality of user terminals, or receive a location of a user terminal designated by the first user terminal from the corresponding user terminal. Here, the interface 201 may receive a current location or a starting location of each of the plurality of user terminals as the locations of the plurality of user terminals.

When receiving the place option, the interface 201 may provide a list including items associated with a purpose of meeting, for example, a coffee, a movie, reading, studying, drinking, eating, and shopping to the first user terminal in which the meeting place recommendation request occurs and receive an item following at least one selecting command for the list from the first user terminal as the place option. In this example, the interface 201 may add transportations, for example, a subway and a bus to the list and provide the list to the first user terminal, thereby providing an environment for recommending the meeting place further based on the transportations.

Also, the interface 201 may provide at least one option field to the first user terminal and receive a place option input through the option field from the first user terminal.

The processor 203 may recommend the meeting place based on the locations of the plurality of user terminals and the place option. Specifically, the processor 203 may determine a point to which a distance from each of the plurality of user terminals is within a preset range based on the locations of the plurality of user terminals. The processor 203 may determine the meeting place based on the determined point and the place option and transmit the determined meeting place to at least one user terminal among the plurality of user terminals. Through this, the processor 203 may recommend a rationally determined meeting place to which distances from the plurality of user terminals are similar and suitable for a purpose of meeting. The processor 203 may determine a point to which a first distance from a user terminal ‘A’ and a second distance from a user terminal ‘B’ are within a preset range, for example, 500 meters (m), search an area within a distance, for example, 1 kilometer (km) set based on the point for a meeting place satisfying a place option of ‘coffee’, and recommend the found meeting place.

When a plurality of meeting places satisfies the place option within the distance, for example, 1 km set based on the point, the processor 203 may transmit a map on which the plurality of meeting places are mapped to the plurality of user terminals and determine a meeting place selected by at least one user terminal from the plurality of meeting places to be an optimal meeting place or determine a meeting place satisfying a set reference to be the optimal meeting place, and recommend the determined meeting place for the plurality of user terminals.

When different meeting places are selected by the plurality of user terminals, the processor 203 may determine a meeting place selected by the first user terminal in which a meeting place recommendation request occurs to be the optimal meeting place or determine, to be the optimal meeting place, a meeting place selected by a relatively greater number, for example, at least a majority of user terminals in comparison to other meeting places.

Also, the processor 203 may determine a meeting place closest from a station, for example, a bus stop and a subway station or a meeting place having a lowest parking fee to be the meeting place satisfying the set reference, that is, the optimal meeting place. In this example, when a type of transportation is received from the first user terminal as the place option, the processor 203 may determine the optimal meeting place by applying the received type of transportation. When ‘bus’ is received as the type of transportation, the processor 203 may determine a meeting place that is closest from a bus stop to be the optimal meeting place. When ‘subway’ is received as the type of transportation, the processor 203 may determine a meeting place that is closest from a subway station to be the optimal meeting place. When ‘car’ is received as the type of transportation, the processor 203 may determine a meeting place having a lowest parking fee to be the optimal meeting place.

When an acceptance message for the recommended meeting place is received from the first user terminal or another user terminal in which a meeting place recommendation request occurs, the processor 203 may transmit a path from each of the locations of the plurality of user terminals to the recommended meeting place to the corresponding user terminal for each type of transportation. When the meeting place is determined by the first user terminal, the processor 203 may transmit a path from each of the locations of the plurality of user terminals to the determined meeting place to the corresponding user terminal for each type of transportation such that each user acknowledges the path in advance.

Also, when the meeting place is determined based on the acceptance message for the recommended meeting place received from the first user terminal or the other user terminal, the processor 203 may provide schedule information including the meeting place and a meeting time at the meeting place to the plurality of user terminals and allow the schedule information to be stored in a second user terminal that requests storage of the schedule information in interconnection with a schedule application. In this example, the processor 203 may inquire of each of the plurality of user terminals about whether to store the schedule information and allows the schedule information to be stored in the second user terminal that requests storage of the schedule information. Through this, the schedule information may be easily stored without separately inputting the schedule information in the second user terminal.

The processor 203 may verify an amount of time for moving from a location of the second user terminal to the recommended meeting place based on real-time traffic information acquired from a traffic server, calculate a starting time based on the amount of time and a meeting time at the meeting place, and transmit an inform message including the calculated starting time to the second user terminal, whereby a user arrives at the meeting place before the meeting time without being disturbed by a traffic situation.

The processor 203 may verify the amount of time for moving from each of the locations of the plurality of user terminals to the recommended meeting place based on the real-time traffic information before a time set based on a meeting time at the meeting place, change the meeting place based on a location of a user terminal corresponding to a largest amount of time for moving to the meeting place, and recommend the changed meeting place. When a user is unable to arrive at the meeting place before the meeting time due to a traffic situation, the processor 203 may recommend a meeting place again based on the traffic situation such that the meeting starts as soon as possible and user satisfaction with meeting place recommendation increases.

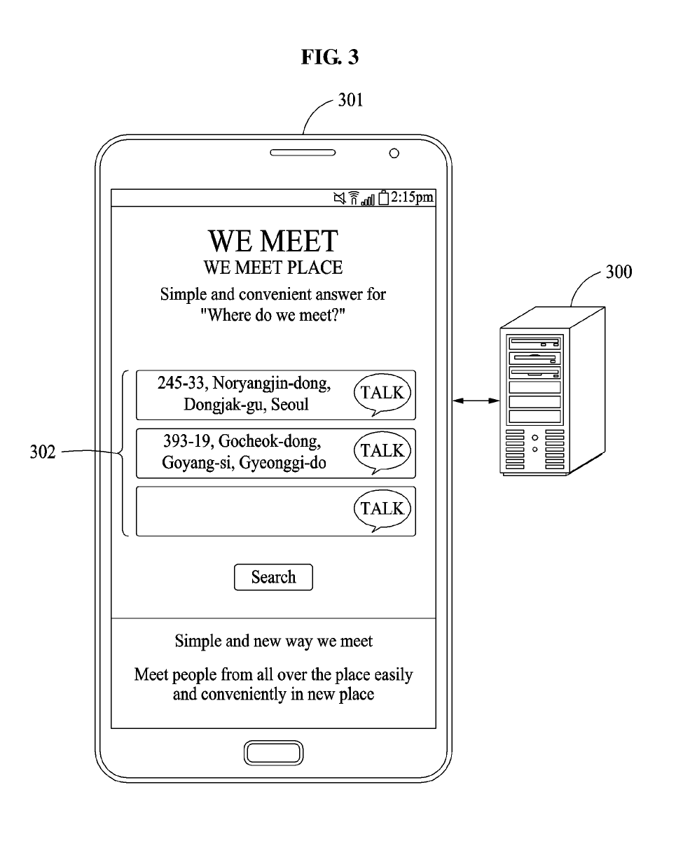

FIG. 3 is a diagram illustrating an example of a meeting place recommending apparatus receiving a location of a user terminal according to an example embodiment.

Referring to FIG. 3, a meeting place recommending apparatus may provide a page including at least one location input field to a user terminal in response to a meeting place recommendation request from the user terminal.

When location information is input to each input field, the meeting place recommending apparatus may receive the location information from the user terminal as a location of each user terminal associated with a meeting. For example, when location information ‘245-33, Noryangjin-dong, Dongjak-gu, Seoul’ of a user terminal ‘A’ 301 and location information ‘393-19, Gocheok-dong, Goyang-si, Gyeonggi-do’ of a user terminal ‘B’ are input in an input field 302 provided to the user terminal ‘A’ 301, a meeting place recommending apparatus 300 may receive locations of the user terminal ‘A’ 301 and the user terminal ‘B’. In this example, the user terminal ‘A’ 301 and the user terminal ‘B’ may be associated with a meeting.

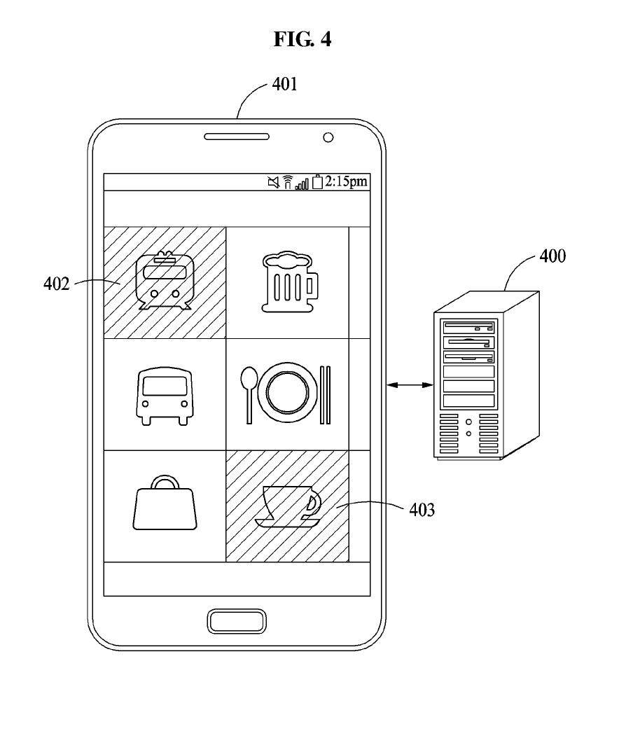

FIG. 4 is a diagram illustrating an example of a meeting place recommending apparatus receiving a place option according to an example embodiment.

Referring to FIG. 4, a meeting place recommending apparatus may provide a list including at least one of a type of transportation, for example, a subway and a bus and an item associated with a purpose of meeting, for example, a coffee, a movie, reading, studying, drinking, and shopping to a user terminal in which a meeting place recommendation request occurs. Also, the meeting place recommending apparatus may receive an item following at least one selecting command for the list from the user terminal as a place option.

For example, a meeting place recommending apparatus 400 may provide a list including image items representing ‘subway, drink, bus, meal, shopping, and coffee’ to a user terminal ‘A’ 401 in which a meeting place recommendation request occurs. When image items 402 and 403 representing ‘subway and coffee’ are selected from the list, the user terminal ‘A’ 401 may receive ‘subway and coffee’ as a place option.

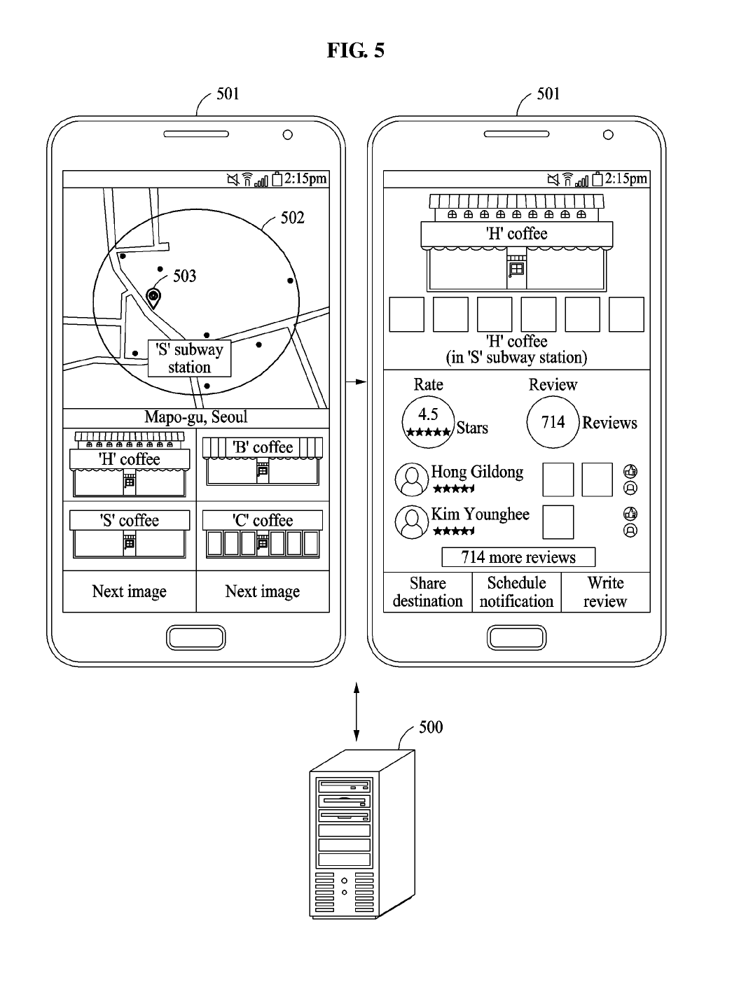

FIG. 5 is a diagram illustrating an example of a meeting place recommending apparatus recommending a meeting place according to an example embodiment.

Referring to FIG. 5, a meeting place recommending apparatus may determine a point to which a distance from each of a plurality of user terminals is within a preset range based on locations of the plurality of user terminals and determine a meeting place based on the determined point and a place option. The meeting place recommending apparatus may transmit the determined meeting place to at least one user terminal among the plurality of user terminals to recommend the meeting place. For example, a meeting place recommending apparatus 500 may determine a meeting place based on locations of a plurality of user terminals received from a user terminal ‘A’ 501, that is, a location of the user terminal ‘A’ associated with a meeting, a location of a user terminal ‘B’ (not shown), and a place option ‘subway and coffee’ received from the user terminal ‘A’ 501 and recommend the determined meeting place to the user terminal ‘A’ 501 and the user terminal ‘B’. In this example, the meeting place recommending apparatus 500 may determine a point to which a first distance from the user terminal ‘A’ 501 and a second distance from the user terminal ‘B’ are within a preset range, for example, 500 m, search an area in a distance 502, for example, 1 km set based on the point for a meeting place satisfying a place option of ‘coffee’, that is, a place where to have coffee, and recommend the found meeting place. In one example, when a plurality of meeting places satisfies the place option of ‘coffee’, the meeting place recommending apparatus 500 may select a meeting place 503, for example, an ‘H’ coffee shop that is closest to a subway station, for example, an ‘S’ subway station from the plurality of meeting places based on the place option ‘subway’ and recommend the selected meeting place as an optimal meeting place.

In another example, when a plurality of meeting places satisfies the place option of ‘coffee’, the meeting place recommending apparatus 500 may transmit a map on which the plurality of meeting places are mapped and information, for example, a name, an image, a rate, and a review of a shop, about the plurality of meeting places to the user terminal ‘A’ 501. When the user terminal ‘A’ 501 selects the ‘H’ coffee shop, the meeting place recommending apparatus 500 determine the ‘H’ coffee shop to be an optimal meeting place and recommend the ‘H’ coffee shop to the user terminal ‘A’ 501 and the user terminal ‘B’.

When the ‘H’ coffee shop is determined to be the meeting place, the meeting place recommending apparatus 500 may provide a map on which a location of the ‘H’ is mapped and information about the ‘H’ coffee shop to the user terminal ‘A’ 501 and the user terminal ‘B’ such that the meeting place is also easily acknowledged by another user terminal associated with the meeting, that is, the user terminal ‘B’ as well as the user terminal ‘A’ 501 having selected the meeting place.

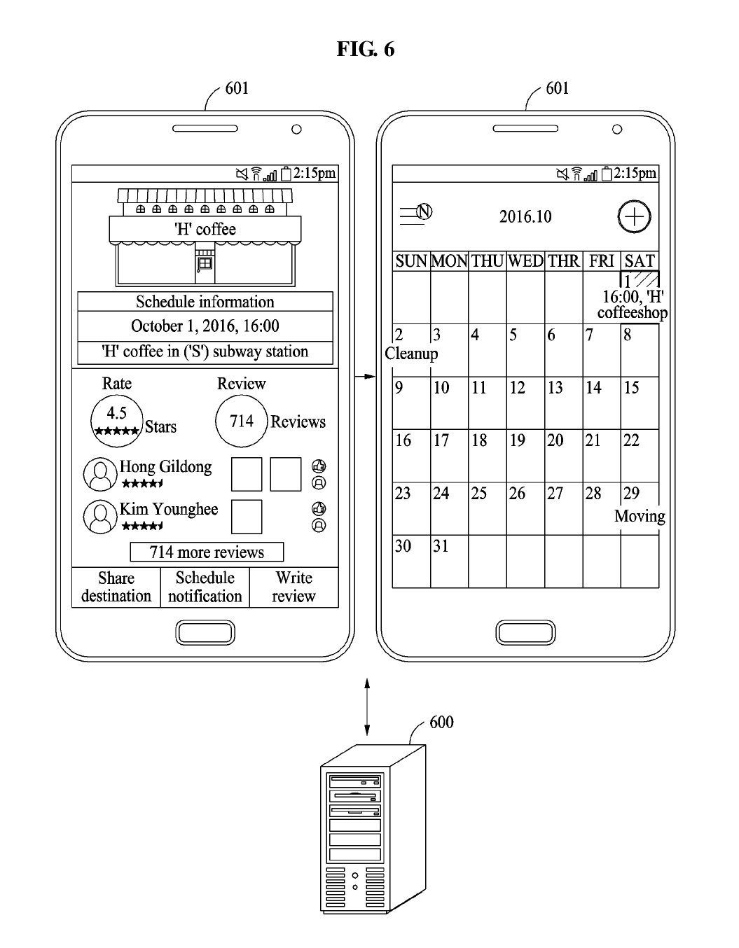

FIG. 6 is a diagram illustrating an example of a meeting place recommending apparatus providing meeting schedule information according to an example embodiment.

Referring to FIG. 6, when a meeting place is determined, a meeting place recommending apparatus may provide schedule information including the meeting place and a meeting time at the meeting place to a plurality of user terminals associated with a meeting.

When a request for storing the schedule information is received from at least one user terminal, the meeting place recommending apparatus may allow the schedule information to be stored in the user terminal in interconnection with a schedule application.

For example, when a meeting place is determined, the meeting place recommending apparatus may provide information ‘October 1, 16:00, ‘H’ coffee shop (in ‘S’ subway station)' to a user terminal ‘A’ and a user terminal ‘B’ as meeting schedule information. When a request for storing the schedule information is received from a user terminal ‘A’ 601, the meeting place recommending apparatus may allow the schedule information to be stored in the user terminal ‘A’ 601 in interconnection with a schedule application.

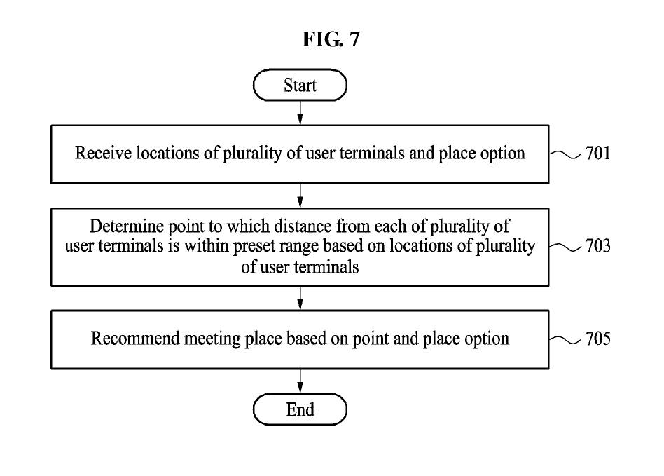

FIG. 7 is a flowchart illustrating a meeting place recommending method according to an example embodiment.

Referring to FIG. 7, in operation 701, a meeting place recommending apparatus may receive locations of a plurality of user terminals and a place option. The meeting place recommending apparatus may receive the locations of the plurality of user terminals associated with a meeting from a first user terminal in which a meeting place recommendation request occurs among the plurality of user terminals, or receive a location of a user terminal designated by the first user terminal from the corresponding user terminal.

When receiving the place option, the meeting place recommending apparatus may provide a list including items associated with a purpose of meeting, for example, a coffee, a movie, reading, studying, drinking, eating, and shopping to the first user terminal in which the meeting place recommendation request occurs and receive an item following at least one selecting command for the list from the first user terminal as the place option. In this example, the meeting place recommending apparatus may add transportations, for example, a subway and a bus to the list and provide the list to the first user terminal.

In operation 703, the meeting place recommending apparatus may determine a point to which a distance from each of the plurality of user terminals is within a preset range based on the locations of the plurality of user terminals.

In operation 705, the meeting place recommending apparatus may recommend a meeting place based on the determined point and the place option.

In one example, when a plurality of meeting places satisfies the place option within a distance set based on the point, the meeting place recommending apparatus may transmit a map on which the plurality of meeting places are mapped to the plurality of user terminals, determine a meeting place selected by at least one user terminal from the plurality of meeting places to be an optimal meeting place, and recommend the determined meeting place for the plurality of user terminals.

In another example, when a plurality of meeting places satisfies the place option within a distance set based on the point, the meeting place recommending apparatus may determine a meeting place satisfying a set reference to be the optimal meeting place and recommend the determined meeting place for the plurality of user terminals. In this example, as the meeting place satisfying the set reference, the meeting place recommending apparatus may determine a meeting place closest from a station, for example, a bus stop and a subway station, or a meeting place having a lowest parking fee to be the optimal meeting place. Here, when the transportations is received from the first user terminal as the place option, the meeting place recommending apparatus may determine the optimal meeting place by applying the received transportations.

When an acceptance message for the recommended meeting place is received from the first user terminal or another user terminal in which the meeting place recommendation request occurs, the meeting place recommending apparatus may transmit a path from each of the locations of the plurality of user terminals to the recommended meeting place to the corresponding user terminal for each type of transportation.

Also, when the meeting place is determined based on the acceptance message for the recommended meeting place received from the first user terminal or the other user terminal, the meeting place recommending apparatus may provide schedule information including the meeting place and a meeting time at the meeting place to the plurality of user terminals and allow the schedule information to be stored in a second user terminal that requests storage of the schedule information in interconnection with a schedule application.

The meeting place recommending apparatus may verify an amount of time for moving from a location of the second user terminal to the recommended meeting place based on real-time traffic information acquired from a traffic server, calculate a starting time based on the amount of time and a meeting time at the meeting place, and transmit an inform message including the calculated starting time to the second user terminal, whereby a user arrives at the meeting place before the meeting time without being disturbed by a traffic situation.

The meeting place recommending apparatus may verify the amount of time for moving from each of the locations of the plurality of user terminals to the recommended meeting place based on the real-time traffic information before a time set based on a meeting time at the meeting place, change the meeting place based on a location of a user terminal corresponding to a largest amount of time for moving to the meeting place, and recommend the changed meeting place.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

### LIST OF REFERENCE NUMBERS

100: Network including meeting place recommending apparatus
101: Plurality of user terminals
103: Meeting place recommending apparatus

1. An apparatus for recommending a meeting place, the apparatus comprising:
an interface configured to receive a place option and locations of a plurality of user terminals; and
a processor configured to determine a point to which a distance from each of the plurality of user terminals is within a preset range based on the locations of the plurality of user terminals and recommend a meeting place based on the determined point and the place option.

2. The apparatus of claim 1, wherein the processor is configured to verify, before a time set based on a meeting time at the meeting place, an amount of time for moving from each of the locations of the plurality of user terminals to the recommended meeting place based on real-time traffic information, change the meeting place based on a location of a user terminal corresponding to a largest amount of time for moving to the meeting place, and recommend the changed meeting place.

3. The apparatus of claim 1, wherein when a plurality of meeting places satisfies the place option within a distance set based on the point, the processor is configured to transmit a map on which the plurality of meeting places are mapped to the plurality of user terminals and determine a meeting place selected by at least one user terminal from the plurality of meeting places to be an optimal meeting place or determine a meeting place satisfying a set reference to be the optimal meeting place, and to recommend the determined meeting place for the plurality of user terminals.

4. The apparatus of claim 3, wherein when different meeting places are selected by the plurality of user terminals, the processor is configured to determine a meeting place selected by a first user terminal in which a meeting place recommendation request occurs to be the optimal meeting place or determine, to be the optimal meeting place, a meeting place selected by a relatively greater number of user terminals in comparison to other meeting places.

5. The apparatus of claim 3, wherein the processor is configured to determine a meeting place closest from a station or a meeting place having a lowest parking fee to be the meeting place satisfying the set reference.

6. The apparatus of claim 1, wherein when an acceptance message for the recommended meeting place is received from a first user terminal in which a meeting place recommendation request occurs, the processor is configured to transmit a path from each of the locations of the plurality of user terminals to the recommended meeting place to the corresponding user terminal for each type of transportation.

7. The apparatus of claim 1, wherein when an acceptance message for the recommended meeting place is received from a first user terminal in which a meeting place recommendation request occurs, the processor is configured to provide schedule information including the meeting place and a meeting time at the meeting place to the plurality of user terminals and allow the schedule information to be stored in a second user terminal that requests storage of the schedule information in interconnection with a schedule application.

8. The apparatus of claim 7, wherein the processor is configured to verify an amount of time for moving from a location of the second user terminal to the recommended meeting place based on real-time traffic information, calculate a starting time based on the amount of time and a meeting time at the meeting place, and transmit an inform message including the calculated starting time to the second user terminal.

9. The apparatus of claim 1, wherein the interface is configured to provide a list including items associated with a purpose of meeting to a first user terminal in which a meeting place recommendation request occurs and receive an item following at least one selecting command for the list from the first user terminal as the place option.

10. A method of recommending a meeting place, the method comprising:
receiving a place option and locations of a plurality of user terminals;
determining a point to which a distance from each of the plurality of user terminals is within a preset range based on the locations of the plurality of user terminals; and
recommending a meeting place based on the determined point and the place option.

11. The method of claim 10, further comprising:
verifying, before a time set based on a meeting time at the meeting place, an amount of time for moving from each of the locations of the plurality of user terminals to the recommended meeting place based on real-time traffic information; and
changing the meeting place based on a location of a user terminal corresponding to a largest amount of time for moving to the meeting place and recommending the changed meeting place.

12. The method of claim 10, wherein when a plurality of meeting places satisfies the place option within a distance set based on the point, the method further comprises:
transmitting a map on which the plurality of meeting places are mapped to the plurality of user terminals and determining a meeting place selected by at least one user terminal from the plurality of meeting places to be an optimal meeting place; or
determining a meeting place satisfying a set reference to be the optimal meeting place; and
recommending the determined meeting place for the plurality of user terminals.

13. The method of claim 12, wherein when different meeting places are selected by the plurality of user terminals, the transmitting of the map further comprises:
determining a meeting place selected by a first user terminal in which a meeting place recommendation request occurs to be the optimal meeting place; or
determining, to be the optimal meeting place, a meeting place selected by a relatively greater number of user terminals in comparison to other meeting places.

14. The method of claim 12, wherein the determining of the meeting place satisfying the set reference to be the optimal meeting place comprises:
determining a meeting place closest from a station or a meeting place having a lowest parking fee to be the meeting place satisfying the set reference.

15. The method of claim 10, wherein when an acceptance message for the recommended meeting place is received from a first user terminal in which a meeting place recommendation request occurs, the method further comprises:
providing schedule information including the meeting place and a meeting time at the meeting place to the plurality of user terminals; and
allowing the schedule information to be stored in a second user terminal that requests storage of the schedule information in interconnection with a schedule application.

16. The method of claim 15, further comprising:
verifying an amount of time for moving from a location of the second user terminal to the recommended meeting place based on real-time traffic information; and
calculating a starting time based on the amount of time and a meeting time at the meeting place and transmitting an inform message including the calculated starting time to the second user terminal.
